(19) United States
(12) Patent Application Publication
(10) Pub. No.: US 2024/0012429 A1
(43) Pub. Date: Jan. 11, 2024

(54) SAFETY NETWORK FOR A MOBILE ROBOT FLEET

(71) Applicant: ABB Schweiz AG, Baden (CH)

(72) Inventors: Zhibo Pang, Västerås (SE); Ognjen Dobrijevic, Västerås (SE); Pawel Wiatr, Upplands Väsby (SE); Krister Landernäs, Hallstahammar (SE)

(21) Appl. No.: 18/253,528

(22) PCT Filed: Nov. 30, 2021
(86) PCT No.: PCT/EP2021/083477

§ 371 Date: May 18, 2023

(30) Foreign Application Priority Data
Dec. 4, 2020 (WO) PCT/EP2020/084675

(51) Int. Cl. G05D 1/02

(52) U.S. Cl. CPC G05D 1/0291

(57) ABSTRACT

A safety network for supporting mobile robots in a facility including: one or more zone safety controllers each operating a zone safety loop responsible for a predefined zone of the facility, including monitoring zone safety sensors and taking actions in response to detected safety events with effect in the zone only; a fleet management system configured to perform mobile robot route planning and repeatedly associate each of the one or more mobile robots with a responsible zone safety controller; and wherein each zone safety loop exchanges safety event messages with an onboard safety loop in each mobile robot, for which the zone safety controller is responsible.

### TECHNICAL FIELD

The present disclosure relates to the field of industrial robotics and to a multi-level safety architecture in particular.

### BACKGROUND

Functional safety is one of the top concerns when mobile robots (MRs) such as automated guided vehicles (AGVs) or autonomous mobile robots (AMRs) are deployed in large industrial facilities. Example facilities include factories, warehouses, ports, and container terminals. Many international standards and regulations, such as IEC 61508 and ISO 13849, should be met if a mobile robot product is to obtain a safety certificate. In conventional safety solutions, the safety controller, sensors, and actuators (a mobile robot may be modelled as a cluster of sensors and actuators) are connected into the same safety loop.

To mention one example, the applicant's earlier application published as WO2018091064A1 discloses an industrial robot system comprising:
robots with respective robot controllers,
a safety sensor configured to detect and supervise persons entering a robot working cell (safety zone) and produce sensor data, and
an information sharing device connected to the safety sensor and the robot controllers.

Different safety zones with independent safety levels can be defined in relation to different safety sensors. The information sharing device distributes sensor data from the safety sensor to the robot controllers, and each robot controller has a safety logic unit for generating safety commands based on sensor data. The safety commands may be generated in accordance with predefined safety function. IEC 61508 edition 2.0 (see for instance part 1, clause 7.16) understands safety function as statically configured items that do not change at runtime. The robot controllers may further include an emergency stop unit capable of stopping the motion of the robot, and each of the safety logic units may be authorized to stop a robot's motion based on received sensor data and received safety commands from the other robot controllers. In particular, the information sharing device may exchange safety commands with the robot controllers, and safety logic units in these may generate further safety commands based on the safety commands received from the other robot controllers.

In an industrial robot system with an architecture of the type just exempli-fied, a sensed safety event normally triggers all the actuators in the safety loop to enter safe mode. Safe modes may include the mobile robots being operated at reduced speed or halted. This meets the basic requirements of the applicable safety regulations, but the productivity may suffer if the system is scaled up. In large facilities and large mobile robot fleets, indeed, one mobile robot may cause other, remotely located robots to stop even though the physical separation does not objectively justify such drastic safety measures. In an ideal safety architecture, a sensed safety event should trigger all necessary safety measures but leave productive the remainder of the robot system.

A further control architecture is known from CN108469786A, which discloses a distributed picking system for a warehouse. The picking system includes a central control server, a plurality of sorting stations, a plurality of mobile robots and a plurality of movable shelves. Each mobile robot completes the handling of different mobile shelves according to the instructions of the central control server, which includes an order processing module, a task assignment module, a global scheduling module, a patch planning module, and a warehouse layout management module. The picking system further comprises scheduling servers deployed at the centers of respective areas of the warehouse, wherein each scheduling server has a task scheduling module, a collision sensing module, a collision classification module, a speed control module, and a partial path planning module. The collision sensing module relies on information reported by each mobile robot to determine whether the mobile robot operates according to its planned path and to assess the risk of a collision.

### SUMMARY

One objective is to make available an improved safety network adapted for mobile robots in an industrial facility. A particular objective is to propose a safety network with a controlled propagation of safety measures taken in response to detected local safety events. Another objective is to propose a safety network with intrinsic resilience. It is a still further objective to make available a mobile robot configured to cooperate with a safety network including any of these improvements.

These and other objectives are achieved by the invention according to the independent claims. The dependent claims relate to advantageous embodiments.

In one aspect, the invention provides a safety network for supporting one or more mobile robots operable in a facility. The network comprises one or more zone safety controllers each operating a zone safety loop L2 responsible for a predefined zone of the facility, including monitoring associated zone safety sensors and taking actions (in particular, direct actions) in response to detected safety events, in accordance with predefined rules and with effect in the zone only; and a fleet management system configured to perform mobile robot route planning and repeatedly associate each of the one or more mobile robots with a (currently) responsible zone safety controller, wherein each zone safety loop L2 is configured to exchange safety event messages with an onboard safety loop L3 operated by an onboard safety controller of each mobile robot for which the zone safety controller is (currently) responsible.

The multi-level structure of the safety network, with its central facility safety loop L1, its spatial partitioning into multiple zone safety loops L2 and the respective on-board safety loops L3 in the mobile robots, allows purposeful control of the reach or scope of a safety event. This may be achieved in that a next higher safety loop has authority to decide whether to forward (or propagate) the event to its peers, where it becomes available to the next lower safety loops. Such decision-making on propagation may be rule-based or carried out for each concrete safety event. The multi-level structure furthermore allows efficient implementation of resilience-oriented dispositions. The multi-level structure may as well render the safety network more amenable to certification under the safety standards discussed initially.

In another aspect of the invention, there is provided a method in a safety network for a facility where mobile robots operate. The method includes, at a zone safety controller, operating a zone safety loop L2 responsible for a predefined zone of the facility, including monitoring associated zone safety sensors and taking actions (in particular, direct actions) in response to detected safety events, in accordance with predefined rules and with effect in the zone only; and, at a fleet management system, performing mobile robot route planning and repeatedly associating each of the mobile robots with a responsible zone safety controller, wherein the zone safety loop L2 includes exchanging safety event messages with an onboard safety loop L3 of one of the mobile robots.

In a further aspect, the invention provides a mobile robot comprising: an onboard safety controller configured to operate an onboard safety loop L3 including monitoring onboard safety sensors and taking actions (in particular, direct actions) in response to detected safety events, in accordance with predefined rules and with effect in the mobile robot only; and a mobile robot controller configured to establish communication with a responsible one of the zone safety controllers and to exchange safety event messages between the onboard safety loop L3 and a zone safety loop L2 operated by a the responsible zone safety controller of the safety network. As described above, the zone safety controller is responsible for a predefined zone of the facility.

This structure and capabilities of the mobile robot allow it to interface aptly with the safety network. Without unnecessary detriment to its productivity, the mobile robot is thereby ensured adequate operating safety in regard of its own integrity, human operators and/or sensitive objects in its vicinity.

In a still further aspect, the invention provides a method in a mobile robot. The method includes, at an onboard safety controller, operating an onboard safety loop L3 including monitoring onboard safety sensors and taking actions (in particular, direct actions) in response to detected safety events, in accordance with predefined rules and with effect in the mobile robot only; and, at a mobile robot controller, establishing communication with a responsible one of the zone safety controllers and exchanging safety event messages between the onboard safety loop L3 and a zone safety loop L2 operated by the responsible zone safety controller of the safety network.

The invention further relates to a computer program containing instructions for causing a computer, or the nodes of the safety network in particular, to carry out the above methods. The computer program may be stored or distributed on a data carrier. As used herein, a “data carrier” may be a transitory data carrier, such as modulated electromagnetic or optical waves, or a non-transitory data carrier. Non-transitory data carriers include volatile and non-volatile memories, such as permanent and non-permanent storages of magnetic, optical, or solid-state type. Still within the scope of “data carrier”, such memories may be fixedly mounted or portable.

As used herein, a “safety loop” may include a criterion that is repeatedly evaluated, e.g., in a periodic, event-based, on-request or other suitable fashion. The criterion may be implemented in software executing on one or more programmable processors. Alternatively, it is expressed as a static hardware configuration or as logic, e.g., an application-specific integrated circuit (ASIC) or a logic solver. The criterion may evaluate to a binary or Boolean value (true/false, bit pattern) or a discrete (integer) or continuous (float) variable. Depending on the outcome of the evaluation, it may be determined that a safety event has or has not been detected, and action may be initiated in response. The criterion may be of the active or passive type, i.e., logic rules of the types “if . . . then . . . ” or “while . . . do . . . ”. A safety loop may furthermore accept and emit communications to and from other safety loops, especially loops at a next higher or next lower hierarchic level of the safety network.

Generally, all terms used in the claims are to be interpreted according to their ordinary meaning in the technical field, unless explicitly defined otherwise herein. All references to “a/an/the element, apparatus, component, means, step, etc.” are to be interpreted openly as referring to at least one instance of the element, apparatus, component, means, step, etc., unless explicitly stated otherwise. The steps of any method disclosed herein do not have to be performed in the exact order disclosed, unless explicitly stated.

### BRIEF DESCRIPTION OF THE DRAWINGS

Aspects and embodiments are now described, by way of example, with reference to the accompanying drawings, on which:

FIG. 1 shows a safety network for mobile robots in a facility, including a facility safety loop L1,

FIG. 2 shows a detail of this safety network, including a zone safety loop L2 and onboard safety loops L3 in the mobile robots; and

FIG. 3 illustrates information exchanges between the safety loops on the three levels of the safety network.

### DETAILED DESCRIPTION

The aspects of the present disclosure will now be described more fully hereinafter with reference to the accompanying drawings, on which certain embodiments of the invention are shown. These aspects may, however, be embodied in many different forms and should not be construed as limiting; rather, these embodiments are provided by way of example so that this disclosure will be thorough and complete, and to fully convey the scope of all aspects of invention to those skilled in the art. Like numbers refer to like elements throughout the description.

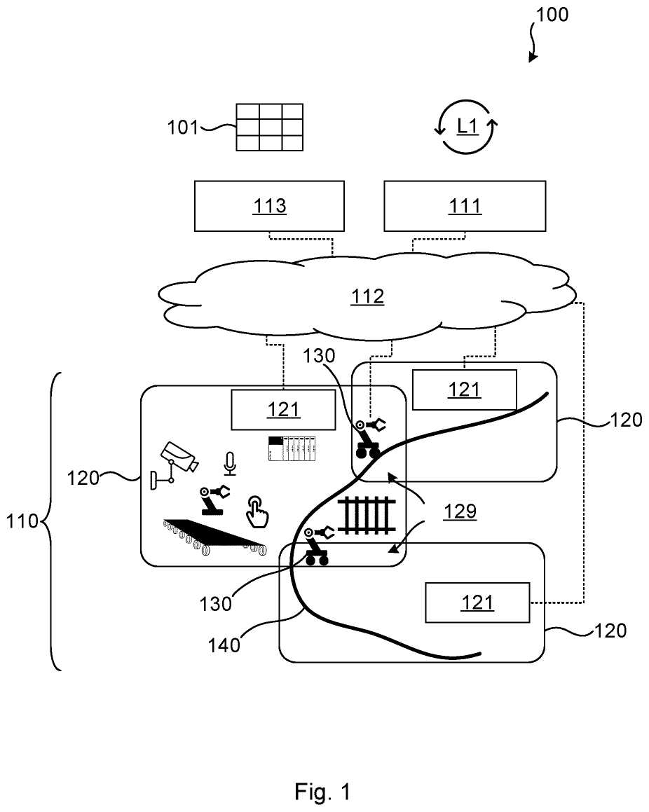

As shown in FIG. 1, the central components of a safety network 100 according to an embodiment of the invention comprises a safety management system 111, a facility network 112 and a fleet management system 113. In the safety management system 111, the hardware or software or both are certified at a higher safety level than the fleet management system 113. In the interest of cost control, since safety-certified equipment may be more onerous to develop and maintain, the safety management system 111 should not be more comprehensive than necessary, but its design should be limited to safety-critical functions that justify the safety certification.

The safety network 100 is installed in a facility 110 (e.g., factory, warehouse, port, container terminal) that is spatially divided into zones 120, each of which is associated with a zone safety controller 121. Mobile robots 130 move along paths 140 extending through one or more zones 120. The zones 120 may coincide with an existing division of the facility into areas (e.g., halls, sectors, fire cells, corridors, work areas, production lines or the like) or may be an independently defined division. The zones 120 may constitute a non-overlapping partition of all parts of the facility 110 where mobile robots 130 operate. Alternatively, like in the example of FIG. 1, the zones 120 may overlap in such manner that some areas 129 may be covered doubly, triply or even more times. The zones 120 may correspond to so-called task zones and/or spans of control in the sense of ISO 13849.

As further shown in FIG. 1, the safety management system 111, fleet management system 113, zone safety controllers 121 and mobile robots 130 are all connected to the facility network 112, which provides wireless or wired data connectivity in all relevant portions of the facility 110. Example high-performing implementations of the facility network 112 may be compliant with any of the standards 3GPP 4G/LTE, 3GPP 5G/NR, WiFi5/6, or a WIA-FA (Wireless Networks for Industrial Automation—Factory Automation). Some use cases may obtain sufficient connectivity by the use of simpler networking infrastructure and protocols, including reduced bandwidth, increased latency etc. The facility network 112 may provide time synchronization; an example accuracy of 10 ms may be sufficient, though this is dependent on the speed at which the mobile robots 130 move and their expected braking distances.

The fleet management system 113 is configured to perform mobile robot route planning and to manage the execution of these routes by the mobile robots 130. The route planning functionality may be configured to achieve one or more of the following safety-relevant or resilience-relevant desiderata:
i) to avoid movement of mobile robots 130 into zones 120 with an ongoing safety event (see below);
ii) to avoid a deficit or excess of mobile robots 130 with a specific functionality or task in some zones 120;
iii) to avoid an accumulation of mobile robots 130 in a single zone 120, e.g., by limiting their number at a threshold value.
   The third point, for instance, may ensure that a safety event in a zone 120 will affect (e.g., halt) only a limited number of mobile robots 130, corresponding to the threshold value chosen. Each of the desiderata may be implemented in a per se known manner. For example, if the route planning is done according to an optimization approach, the target function may be defined in a way that penalizes the behavior to be avoided and thereby favors alternative route options.

Further, the fleet management system 113 periodically collects the locations of all the mobile robots 130. The fleet management system 113 is configured to repeatedly associate each of the mobile robots 130 with a currently responsible zone safety controller 121. For this purpose, in some embodiments, the fleet management system 113, on this basis, could generate and update an association table (AT) 101, which may have the following example appearance:

TABLE 1
(Predictive) Association Table

| | | | | | |
|---|---|---|---|---|---|
| Zone #1 | Zone #2 | Zone #3 | Zone #4 | . . . | Zone #N |

| | | | | | |
|---|---|---|---|---|---|
| Mobile Robot #1 | 1 | | | | |
| Mobile Robot #2 | 1 | 1 | | | |
| Mobile Robot #3 | | 1 | 1 | | |
| Mobile Robot #4 | | | 1 | 1 | |
| . . . | | | | | |
| Mobile Robot #M | | | | | 1 |

If a certain mobile robot 130 belongs to a certain zone 120, the corresponding item in the AT is set to true or 1, or otherwise set to false or 0 (shown above as blanks). The fleet management system 113 thereby ensures that every mobile robot 130 belongs to at least one zone 120. (In some embodiments, the stricter criterion that each mobile robot 130 shall belong to exactly one zone 120 is imposed.) Because the facility 110 is in coverage by the facility network 112, the assignment of a mobile robot 130 to a zone 120 can be likened to a pure bookkeeping operation that does not require any direct handshaking or interlocking between the mobile robot 130 and the safety equipment in the zone 120. Such actions may otherwise be required for the establishment of a new wireless communication link.

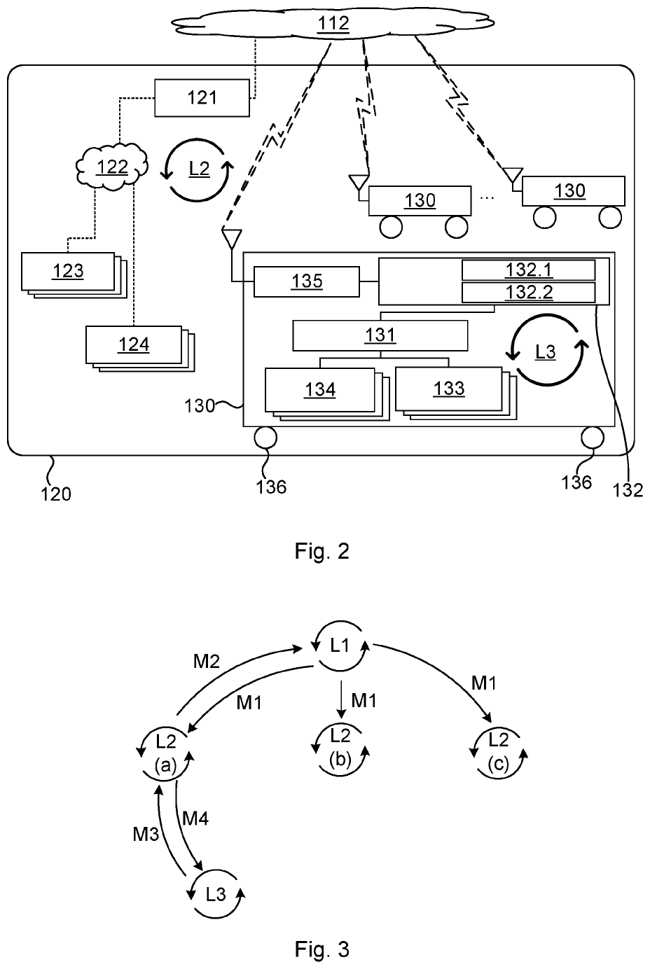

The fleet management system 113 may also generate at least one predictive association table (PAT) based on one or more predicted movement paths (or routes) 140 of the mobile robots 130. A predicted movement path 140 may be a regular planned movement path, a planned movement path adjusted due to a safety event, an extrapolation of an ongoing movement path or a combination of these. The predicted path 140 may be generated by either the fleet management system 113, a mobile robot controller 132 (FIG. 2) of the mobile robot 130 concerned, or by the fleet management system 113 and mobile robot controller 132 in collaboration. The fleet management system 113 can generate multiple PATs to be used at different future moments, with longer term prediction and path planning. The availability of at least one PAT provides resilience against packet drops and other temporary communication problems, by allowing the zone safety controller 121 to remain operable through such conditions, in the manner explained below.

Safety-related devices are installed throughout the facility 110, including sensors (e.g., manual emergency switches, cameras, microphones, light curtains, possibly supported by advanced sensing technologies, such as machine-learning based methods), actuators (e.g., relays, switchgears, motors, speakers, light) and safety controllers on different levels. Non-robot-carried safety devices operating at the decentral level on safety-zone level are partitioned into the zones 120 according to the locations of the devices and the automation processes that the devices are involved in. Robot-carried safety devices, for their part, are partitioned into different mobile robots 130 in the evident way. As already noted, a zone 120 can correspond to a robot cell, a production line, a space shared by humans and robots, and even a virtual area that is defined in the safety management system 111. Complex equipment, such as transport systems and robots, may be modeled as clusters of sensors and actuators.

FIG. 2 is a detailed view of a zone 120, which is seen to include the zone safety controller 121, a zone network 122, which links the zone safety controller 121 to a collection of zone safety actuators 123 and a collection of zone safety sensors 124 (e.g., an emergency stop switch, an optical presence sensor, a camera, an acoustic sensor). The zone network 122 may be an integral part of the facility network 112 or otherwise be separate from the facility network 112 in certain respects. A number of mobile robots 130 are dynamically associated with the zone 120, typically on the basis of their present or predicted physical locations.

Each mobile robot 130 further comprises a communication interface 135, a mobile robot controller 132, an onboard safety controller 131, a collection of onboard safety actuators 133 and onboard safety sensors 134. In the mobile robot controller 132 there are two virtual sensors, preferably implemented in software, acting as a bridge for a message exchange between the mobile robot's 130 onboard safety loop L3 and the zone safety loop L2 of the zone safety controller 121 that is currently in charge of (or responsible for) the mobile robot 130. The virtual sensors include a virtual zone-to-onboard sensor 132.1, which is configured to obtain (and optionally store) safety events to be communicated from the zone safety controller 121 to the onboard safety controller 131, and a virtual onboard-to-zone sensor 132.2, which is configured to obtain (and optionally store) safety events to be communicated from the onboard safety controller 131 to the zone safety controller 121. The safety events obtained by the virtual sensors 132.1, 132.2 may have been originally generated by the onboard safety actuators 134. By handling and optionally (temporarily) storing the safety event messages, the components of the mobile robot controller 132 thus act as a message bridge. The mobile robot 130 is further equipped with propulsion means 136, which may be adapted for movement over a flat, sloping, or curved surface or along pre-mounted rails, wherein the mobile robot 130 may constitute an automated guided vehicle (AGV) or an autonomous mobile robot (AMR).

The safety related functionalities and processes are partitioned into three types: a facility safety loop L1, zone safety loops L2, and onboard safety loops L3.

On the top level, in the facility safety loop L1 indicated in FIG. 1, the coordinates of the defined zones 120, referring to a common map of the facility 110, are provided by the safety management system 111 to the fleet management system 113 periodically or upon request. This functionality is optional and may not need to be implemented in a safety network 100 intended for facilities where the zones 120 do not change over time, or do not change more often than reconfiguration intervals that are acceptable to the facility operator. In a safety network 100 for such a use case, the zone coordinates can be pre-stored in the fleet management system 113. The fleet management system 113 also generates a timestamp to indicate a validity period of the AT and the PAT, if applicable. The fleet management system 113 may be configured to notify the safety management system 111 whenever there is a change in the AT or PAT. Having received such notification, the safety management system 111 may share, via the facility network 112, updated AT and PAT with the zone safety controllers 121. Alternatively, the safety management system 111 may extract relevant parts of the updated AT and PAT (e.g., indications of such mobile robots 130 that are to be reassigned between two zone safety controllers 121) and shares it with those of the zone safety controllers 121 that are affected by the change.

In the zone safety loop L2 indicated in FIG. 2, the executing zone safety controller 121 periodically scans the status of the zone safety sensors 124 and mobile robots 130 that belong to its zone 120, takes actions by activating the zone safety actuators 123 according to predefined rules if a safety event is detected. The periodical scanning may further include the virtual onboard-to-zone sensors 132.2, if any. The (direct) actions taken by the zone safety loop L2 have effect in that zone 120 only. To minimize network traffic, only the mobile robots 130 which are marked as 1 in the corresponding column of the AT or PAT (i.e., present in the zone 120) are scanned. When a valid AT is available, the zone safety controller 121 uses the information in the AT; otherwise, it relies on the PAT. If timestamps or other factors indicate that neither the AT nor the PAT is valid, a safety event will be triggered and reported to the central safety management system 111.

In an onboard safety loop L3, as illustrated in FIG. 2, the onboard safety controller 131 periodically scans the status of the onboard safety sensors 134 and the virtual zone-to-onboard sensor 132.1. If a safety event is detected, it takes an action—or initiates such action—via the onboard safety actuators 133 and the virtual onboard-to-zone sensor 132.2, according to predefined rules for this safety event. The actions taken by the onboard safety loop L3 have effect in the mobile robot 130 only.

FIG. 3 illustrates data messages exchanged between the safety loops on the three levels of the safety network 100. Here, L2(a), L2(b), L2(c) denote zone safety loops implemented in zone safety controllers 121 of three different zones 120, like those shown in FIG. 1. It is understood that more than one mobile robot 130 may operate in the facility 110, though for simplicity only one onboard safety loop L3 has been illustrated.

The facility network 112 is the default carrier of the data messages to be described, although different infrastructure (e.g., short-range wireless) is conceivable and may respond more adequately to specific needs. This may be the case when a zone safety controller 121 is to communicate wirelessly with a mobile robot 130 in an area of the facility 110 with numerous RF-reflective or RF-absorbing obstacles which is therefore difficult to cover by the facility network 112.

As described above, the safety management system 111 shares, via the facility network 112, updated AT and PAT—or relevant parts thereof—with the zone safety controllers 121. At the level of the safety loops, this may be visualized as the messages M1 in FIG. 3, which are communicated from the facility safety loop L1 to all, or certain ones of the zone safety loops L2(a), L2(b), L2(c). The individual messages that carry the common label M1 could differ in content in such embodiments where, as described above, the indications of mobile robots 130 to be reassigned between two zone safety controllers 121 is shared only with those of the zone safety controllers 121 that are affected by the reassignment.

Each zone safety controller 121 is configured to report safety events to the safety management system 111. Such reporting is carried in messages M2. Further, each onboard safety controller 131 is configured to exchange information about ongoing safety events with the responsible zone safety controller 121, and this corresponds to messages M3 and M4. The information flow in messages M3 and M4 allows the zone safety loop L2 to respond to a safety event, which was initially detected by the onboard safety loop L3 in a mobile robot 130, by activating zone safety actuators 123 in the zone 120 or activating onboard safety actuators 133 in other mobile robots 130. It also allows a mobile robot 130 to act in concert with a safety action taken in the rest of the zone in such cases where the safety event was detected by the zone safety loop L2 or an onboard safety loop L3 of another mobile robot 130. The exchange of messages M3 and M4 in combination with the next level reporting M2 ultimately allows facility safety loop L1 to respond by facility-wide action to a safety event which was initially detected by zone safety loop L2 or even an onboard safety loop L3.

As an optional feature, the safety management system 111 may be configured to deliver a notification to the fleet management system 113 if all mobile robots 130 in a zone 120 have been stopped. The notified information can be used by the fleet management system 113 to adapt the path planning for mobile robots 130 outside the affected zone 120. For example, the fleet management system 113 is thereby enabled to achieve above-mentioned point i), to avoid movement of mobile robots 130 into zones 120 with an ongoing safety event.

The partition of the safety loops into three levels means they can be deployed in different physical devices including edge/cloud platform solutions. This favors flexibility and allows redundancy to be implemented easier and at lower cost.

By structuring the interaction between the loops L1, L2, L3 in the manner described, the facility 110 and the mobile robots 130 operating therein are physically decoupled but maintained logically interoperable in a near-gapless fashion. The safety events from safety sensors on different levels can be handled and responded to timely and appropriately. For example, a normal safety event in a mobile robot 130 can trigger action in the robot 130 itself, or, if the event is potentially more serious, zone safety actuators 123 of the local zones 120 may be involved. In a well configured safety network 100 of this type, it is normally possible to avoid over-responding (e.g., by all safety actuators indiscriminately).

In some embodiments, the communication among the devices, including the safety management system 111, the fleet management system 113, zone safety controllers 121, zone safety actuators 123, zone safety sensors 124 and mobile robots 130, can be implemented by periodical polling or publication—subscription, wherein the sender places the information in a shared memory from which the receiver has authority to read. The publication—subscription approach is especially advantageous in wireless networks, where it efficiently limits the amount of network resources that is spent on communication attempts which fail due to the non-availability of the receiver. The expenditure of resources on polling may be well offset by such savings. Publication—subscription may be applied also to such communications that are termed “notifications” above.

In other embodiments, there are safety loops on four or more levels. For example, one zone 120 can include multiple sub-zones (not shown) in which independent sub-zone safety loops execute. This is advantageous when it is expected that some safety events may affect the entire zone 120 (e.g., a production line) but the zone is too large or too diverse to be monitored by a single zone safety loop L2. Another reason to subdivide a zone 120 into sub-zones is where there is a relatively high incidence of localized safety events in no need of being escalated to the full zone 120, while data from all parts of the zone 120 are relevant for the proper understanding or interpretation of a reported local safety event. In still other embodiments, each of these (three, four or more) levels may include sub-levels with at least one safety loop in each. A level may even contain a sub-hierarchy of two or more loops which interact in the manner described above. In particular, one of the zones may include multiple sub-loops of the L2 type, and possibly with an internal hierarchy between these.

In further embodiments, the safety management system 111, the zone safety controllers 121 and/or the onboard safety controllers 131 are implemented with hardware or software redundancy. For example, zone safety controllers 121 of spatially adjacent zones 120 may have a readiness to serve as each other's backups, by operating in a so-called hot standby (or hot spare) mode until the backup becomes necessary. Hot standby operation may include mimicking relevant aspects of the active unit's behavior, especially regarding incoming signals and decision-making on their basis. This way, the hot standby unit will have an internal state that is identical—or identical in relevant parts—to that of the active unit, allowing the former to assume the duties of the latter in a seamless manner. The hot standby unit need not belong to a different network entity but may be implemented in the same entity, though with some operative independence to avoid propagation of a failure. As one example, the safety management system 111 may have two processors executing identical copies of the facility safety loop L1 and on the basis of same messages and sensor signals, though only one of the loops L1 (main) is configured and authorized to take action with effect on the facility 110 or mobile robots 130. The two processors may have separate power supplies and/or network connections, whereby the impact of an externally originated failure is limited to one of the processors, so that the hot standby loop L1 executing on the not-affected processor may assume the role as main facility safety loop L1 without significant delay.

Redundancy according to this design approach could be implemented even in a safety network 100 where a mobile robot 130 always belongs to a predefined one of the zones 120. It is convenient to let adjacent zone safety controllers 121 step in for each other, because some zone safety sensors 124 may be able to monitor also portions of the next zone 120, and further because sensor and actuator signals need not travel great distances over communication links. On the other hand, especially if a fast facility network 112 is available, there is nothing to prevent a non-adjacent (or even remote) zone safety controller from acting as replacement. It is understood that the zone safety controller 121, during a replacement of any of the types described, may keep executing the zone safety loop L2 in its home zone.

The aspects of the present disclosure have mainly been described above with reference to a few embodiments. However, as is readily appreciated by a person skilled in the art, other embodiments than the ones disclosed above are equally possible within the scope of the invention, as defined by the appended patent claims. For example, a safety network 100 with the architecture described herein may also be advantageously deployed to support mobile robots 130 that are autonomous surface vehicles (USVs), autonomous underwater vehicles (AUVs) or unmanned aerial vehicles (UAVs). Such generalization, which may optionally include defining the zones 120 in three dimensions, is within the capabilities of an average practitioner having studied and understood the present disclosure.

1. A safety network for supporting one or more mobile robots operable in a facility, the network comprising:
one or more zone safety controllers each operating a zone safety loop-responsible for a predefined zone of the facility, including monitoring associated zone safety sensors and taking actions in response to detected safety events, in accordance with predefined rules and with effect in the zone only; and
a fleet management system configured to perform mobile robot route planning and to repeatedly assign each of the one or more mobile robots to a responsible zone safety controller,
wherein each zone safety loop is configured to exchange safety event messages with an onboard safety loop operated by an onboard safety controller of each mobile robot for which the zone safety controller is responsible.

2. The safety network of claim 1, wherein the fleet management system is configured to perform each assignment on the basis of the respective mobile robot's present or predicted physical location.

3. The safety network of claim 1, further comprising:
a safety management system operating a facility safety loop including including obtaining assignment updates from the fleet management system and making indications of such mobile robots that are to be reassigned between two zone safety controllers available to those of the zone safety controllers that are affected by the reassignment.

4. The safety network of claim 3, wherein each zone safety controller is configured to report safety events, to the safety management system.

5. The safety network of claim 3, wherein the safety management system is configured to exchange information relating to ongoing safety events with the fleet management system.

6. The safety network of claim 3, wherein hardware and/or software of the safety management system is certified at a higher safety level than the fleet management system.

7. The safety network of claim 1, wherein operating the zone safety loop further includes activating associated zone safety actuators in response to a detected safety event.

8. The safety network of claim 1, wherein the zone safety sensors include one or more of: an emergency stop switch, an optical presence sensor, a camera, an acoustic sensor.

9. The safety network of claim 1, wherein the fleet management system is configured to perform the repeated assignment by maintaining an association table indicating for each of the one or more mobile robots the responsible zone safety controller.

10. The safety network of claim 9 further comprising a safety management system operating a facility safety loop, including obtaining assignment updates from the fleet management system and making indications of such mobile robots that are to be reassigned between two zone safety controllers available to those of the zone safety controllers that are affected by the reassignment, and wherein the fleet management system is further configured to generate a predictive association table on the basis of predicted movement paths of the mobile robots the facility safety loop including obtaining the predictive association table from the fleet management system.

11. The safety network of claim 10, wherein the predicted movement paths include one or more of: a regular planned movement path, a planned movement path adjusted due to a safety event, an extrapolation of an ongoing movement path.

12. The safety network of claim 1, wherein at least one zone safety controller is configured to operate in hot standby mode to provide redundancy to one or more other zone safety controllers.

13. The safety network of claim 1, wherein the safety event message exchange between the facility safety loop and the zone safety loop and/or between the zone safety loop and the onboard safety loop and/or, if applicable, the exchange of ongoing safety event information between the safety management system and fleet management system is effectuated on the basis of periodical polling or publication—subscription.

14. The safety network of claim 1, wherein the fleet management system is configured to avoid movement of mobile robots into zones with an ongoing safety event.

15. The safety network of wherein the fleet management system is configured to avoid a deficit or excess of mobile robots with a specific functionality in some zones.

16. The safety network of wherein the fleet management system is configured to avoid an accumulation of mobile robots in a single zone.

17. A mobile robot operable in a facility in which a safety network with multiple zone safety controllers supports one or more mobile robots, the mobile robot comprising:
an onboard safety controller configured to operate an onboard safety loop including monitoring onboard safety sensors and taking actions in response to detected safety events, in accordance with predefined rules and with effect in the mobile robot only; and
a mobile robot controller configured to establish communication with a responsible one of the zone safety controllers and to exchange safety event messages between the onboard safety loop and a zone safety loop operated by the responsible zone safety controller.

18. The mobile robot of claim 17, wherein the mobile robot controller is further configured to act as a bridge for the exchange of the safety event messages.

19. The mobile robot of claim 17 wherein operating the onboard safety loop includes activating associated onboard safety actuators in response to a detected safety event.

20. The mobile robot of claim 17, wherein the safety event message exchange between the zone safety loop and the onboard safety loop is effectuated on the basis of periodical polling or publication— subscription.

21. The mobile robot of claim 17, which is an automated guided vehicle, AGV, or an autonomous mobile robot, AMR.
